(19) United States
(12) Patent Application Publication
(10) Pub. No.: US 2016/0025260 A1
(43) Pub. Date: Jan. 28, 2016

(54) HINGED PEDESTAL BASES

(71) Applicant: Emerson Network Power, Energy Systems, North America, Inc., Warrenville, IL (US)

(72) Inventors: Simon Shen-Meng CHEN, Palatine, IL (US); Jerome A. MALONEY, Sugar Grove, IL (US)

(21) Appl. No.: 14/657,848

(22) Filed: Mar. 13, 2015

Related U.S. Application Data
(60) Provisional application No. 62/028,700, filed on Jul. 24, 2014.
(60) Provisional application No. 62/048,034, filed on Sep. 9, 2014.

(51) Int. Cl. F16M 11/22

(52) U.S. Cl. CPC F16M 11/22

(57) ABSTRACT

A telecommunications pedestal base includes a first base portion having a wall with a first edge, a second base portion having a wall with a second edge positioned adjacent the first edge, and a hinge coupled to the first base portion and the second base portion. The first base portion is movable about the hinge relative to the second base portion to separate the first edge from the second edge and form an opening between the first edge and the second edge. The opening provides access to an interior of the base. Other example telecommunications pedestal bases, distribution pedestals, and methods of installing telecommunications pedestal bases are also disclosed.

### CROSS-REFERENCE TO RELATED APPLICATIONS

This application claims the benefit of U.S. Provisional Application No. 62/028,700 filed Jul. 24, 2014 and U.S. Provisional Application No. 62/048,034 filed Sep. 9, 2014. The entire disclosure of each of the above applications is incorporated herein by reference.

### FIELD

The present disclosure relates to hinged pedestal bases.

### BACKGROUND

This section provides background information related to the present disclosure which is not necessarily prior art.

Distribution terminal pedestals include a base and a dome supported by the base. Typically, the base is a single piece construction or a two piece construction. The two piece construction (sometimes referred to as a split base construction) is formed with two base components which may disengage and separate entirely from each other. Alternatively, the single piece construction is formed of a single base component.

### SUMMARY

This section provides a general summary of the disclosure, and is not a comprehensive disclosure of its full scope or all of its features.

According to one aspect of the present disclosure, a telecommunications pedestal base includes a first base portion having a wall with a first edge, a second base portion having a wall with a second edge positioned adjacent the first edge, and a hinge coupled to the first base portion and the second base portion. The first base portion is movable about the hinge relative to the second base portion to separate the first edge from the second edge and form an opening between the first edge and the second edge. The opening provides access to an interior of the base.

According to another aspect of the present disclosure, a method of installing a telecommunications pedestal base about cables in a telecommunications system is disclosed. The telecommunications pedestal base includes a first base portion having a first edge, a second base portion having a second edge adjacent the first edge, and a hinge coupled to the first base portion and the second base portion. The method includes separating the first edge of the first base portion from the second edge of the second base portion so that the first base portion moves about the hinge relative to the second base portion to form an opening between the first edge and the second edge, and moving the telecommunications pedestal base to allow the cables to pass through the opening between the first edge and the second edge and into an interior of the base.

Further areas of applicability will become apparent from the description provided herein. It should be understood that various aspects of the disclosure may be implemented individually or in combination with one or more other aspects. It should also be understood that the description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an isometric view of a base including an integrated hinge according to one example embodiment of the present disclosure.

FIG. 2 is a cross sectional top view of the base of FIG. 1.

FIG. 3 is an enlarged portion of the integrated hinge of FIG. 1.

FIG. 4 is an enlarged portion of a corner of the base of FIG. 1, opposite the integrated hinge.

FIG. 5 is a top view of the base of FIG. 1 having an opening at the corner of the base of FIG. 1 opposite the integrated hinge.

FIG. 6 is an isometric view of a base including the integrated hinge of FIG. 1 and a tongue and slot fastening structure according to another example embodiment.

FIG. 7 is a cross sectional top view of the base of FIG. 6.

FIG. 8 is an enlarged portion of the fastening structure of FIG. 6.

FIG. 9 is an isometric view of a base including the integrated hinge of FIG. 1 and a fastening structure according to yet another example embodiment.

FIG. 10 is a cross sectional top view of the base of FIG. 9.

FIG. 11 is an enlarged portion of the fastening structure of FIG. 9.

FIG. 12 is an isometric view of a base including the integrated hinge of FIG. 1 and a bayonet fastening structure according to another example embodiment.

FIG. 13 is a cross sectional top view of the base of FIG. 12.

FIG. 14 is an enlarged portion of the fastening structure of FIG. 12.

FIG. 15 is a cross sectional top view of a base including three walls according to yet another example embodiment.

FIG. 16 is a cross sectional top view of a base including two walls according to another example embodiment.

FIG. 17 is a top view of a portion of the base having a detachably hinge according to yet another example embodiment.

FIG. 18 is an isometric view of a distribution pedestal including the base of FIG. 6 according to another example embodiment.

Corresponding reference numerals indicate corresponding parts or features throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

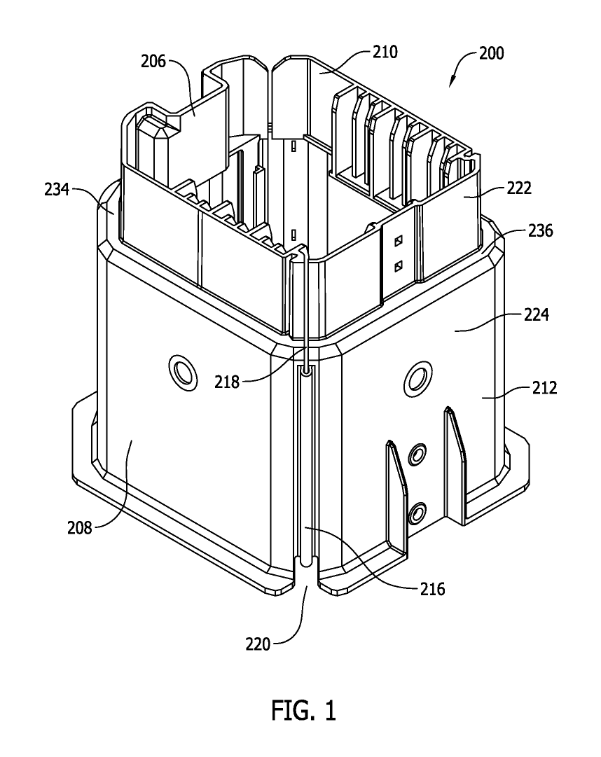

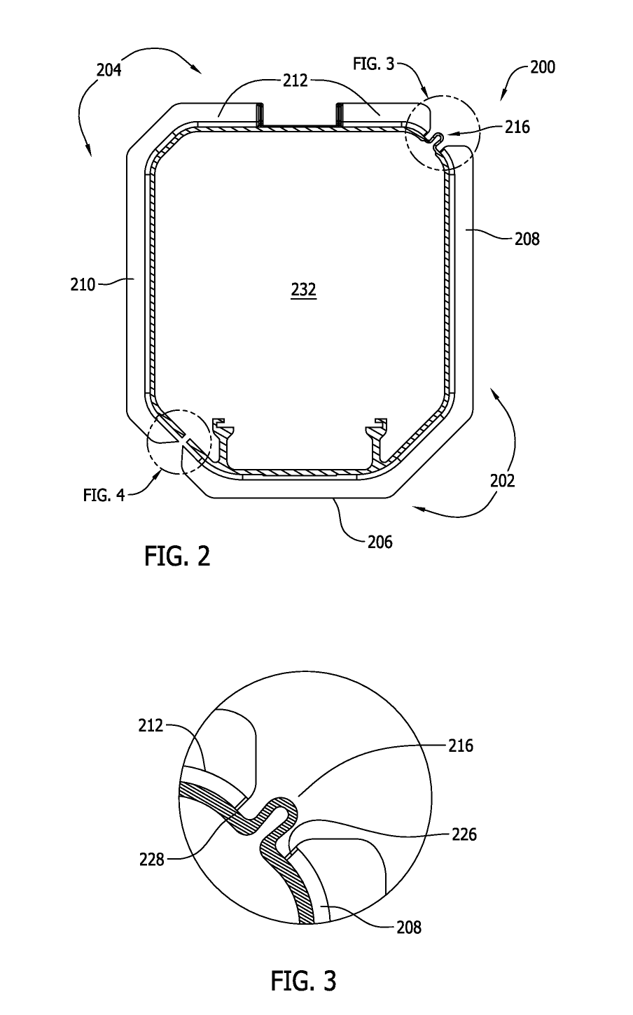

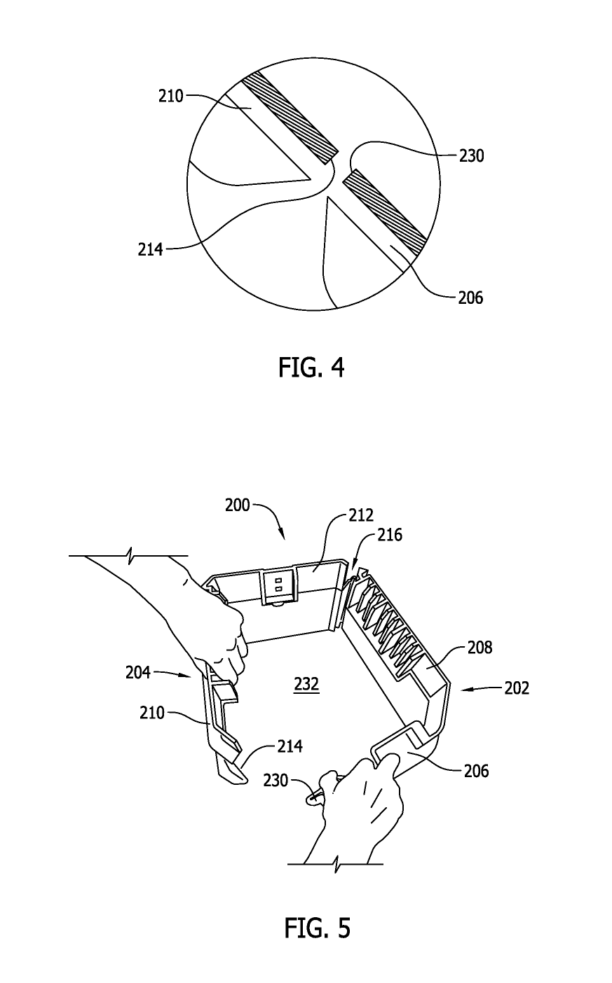

A telecommunications pedestal base according to one example embodiment of the present disclosure is illustrated in FIGS. 1-5 and indicated generally by reference number 200. As shown in FIGS. 1-5, the base 200 includes base portions 202, 204, and a hinge 216 coupled to the base portions 202, 204. The base portion 202 includes a wall 206 having an edge 230. The base portion 204 includes a wall 210 having an edge 214 positioned adjacent the edge 230. The base portion 202 is movable about the hinge 216 relative to the base portion 204 to separate the edge 230 from the edge 214 and form an opening between the edge 230 and the edge 214. The opening provides access to an interior 232 of the base 200.

By utilizing the hinge 216 coupled to the base portions 202, 204, a user can separate walls 206, 210 to access the interior 232 of the base 200 to install, repair, replace, etc. components (e.g., cables, etc.). As such, the interior 232 of the hinged base 200 and the components therein may be accessible without, for example, lifting the base 200, completely separating the base portions 202, 204 to expose the components, etc. As a result, cables may be installed, repaired, replaced, modified, etc. with greater ease than other known bases.

In some embodiments, the base portions 202, 204 (and therefore the edges 214, 230) can be separated by force. For example, a user can apply a force to one or both base portions 202, 204 causing the walls 206, 210 (and therefore the edges 214, 230) to separate from each other and form the opening between the edges 214, 230 as explained above.

For example, FIG. 5 illustrates the base portions 202, 204 being separated by a user applying a force. As shown in FIG. 5, one or both base portions 202, 204 are forced to move about the hinge 216 relative to the other base portion to separate the edges 214, 230 and form the opening therebetween.

When the edges 214, 230 are separated, the distance between the edges 214, 230 (e.g., the opening) may be large enough for a user to move the base 200 to allow components (e.g., cables, etc.) to pass through the opening between the edges 214, 230 and into the interior 232 of the base 200. In some embodiments, the distance between the edges 214, 230 may be about 4.5 inches. Alternatively, the walls 206, 208, 210, 212, the hinge 216, etc. may be configured differently such that the distance between the edges 214, 230 is more or less than 4.5 inches.

After which, the base portions 202, 204 may return to their initial position such that the edge 214 of the wall 210 is adjacent the edge 230 of the wall 206. For example, a user can disengage the base 200 allowing the base portions 202, 204 to retract to its initial position and thus substantially closing the opening between the edges 214, 230 without applying an external force. This may be caused by, for example, the resiliency of one or both base portions 202, 204 and/or the hinge 216, the configuration of the base 200, etc. Thus, one or both edges 214, 230 may substantially return to its position such that one edge is adjacent the other edge when the force (explained above) is removed.

Additionally and alternatively, a user can apply a force to the base portions 202, 204 to make the edges 214, 230 return to their initial position. In such cases, this force can be an inwardly directed force (relative to the center of the base 200) to one or more of the walls (e.g., the walls 206, 210, etc.).

In the example embodiment of FIGS. 1-5, the base portion 202 includes the wall 206 (as explained above) and another wall 208 coupled to the wall 206 and the base portion 204 includes the wall 210 (as explained above) and another wall 212 coupled to the wall 210. Thus, each base portion 202, 204 includes two walls and forms a substantially square shape with respect to a top view of the base 200. Alternatively, and as further explained below, one or both base portions may include more or less walls and/or form another suitable shape without departing from the scope of the present disclosure.

As shown in FIGS. 1-3, and 5, the hinge 216 is coupled between edges 226, 228 of the walls 208, 212, respectively. As such, the hinge 216 is positioned in a corner of the base 200 opposite the opening formed between the edges 214, 230 when one or both base portions 202, 204 are moved about the hinge 216. Such a configuration may allow for more separation between the base portions 202, 204, optimize an interface with pedestal dome (e.g., less interfering components, etc.), etc. Alternatively, the hinge 216 and/or the opening providing access to the interior 232 of the base 200 may be positioned on opposing side walls (e.g., not in a corner), in different corners (e.g., adjacent corners as further explained below, etc.), etc.

The hinge 216 is a substantially vertical hinge. For example, the hinge 216 extends in a parallel relationship with the edges 226, 228 of the walls 208, 212, respectively. Alternatively, the hinge 216 may extend in another suitable manner relative to the edges 226, 228 if desired.

As shown best in FIG. 1, the base 200 includes a slot 218 above the hinge 216 and a slot 220 below the hinge 216 to create separation between the walls 208, 212. In such cases, the hinge 216 extends a distance less than a height of the base 200. For example, it may be preferable that the hinge 216 does not extend into an upper portion 222 of the base 200 that receives a dome of a distribution pedestal as further explained below. Alternatively, the hinge 216 may extend substantially the entire height of the base 200 (including the upper portion 222 of the base 200), substantially the entire height of a lower portion 224 (e.g., the portion below the upper portion 222) of the base 200, etc.

As shown best in FIGS. 1-3, the hinge 216 has a reverse bubble shape. For example, the hinge 216 includes an outer rounded portion and two substantially linear portions extending inwardly towards each other away from the outer rounded portion. In the example of FIGS. 1-5, the two substantially linear portions are coupled to the walls 208, 212 as explained above.

This configuration may provide the hinge 216 with suitable flexibility and resiliency to allow the base portions 202, 204 (and therefore the edges 214, 230) to separate and/or retract as described above. For example, the hinge 216 may flex as a force is applied. In particular, the linear portions of the hinge 216 may flex outwardly from each other to allow the edges 214, 230 to separate as explained above. Alternatively, the hinge 216 may have another suitable shape, configuration, etc. as further explained below without departing from the scope of the present disclosure.

As shown best in FIG. 3, the hinge 216 has a uniform thickness which is less than a thickness of the walls 208, 212. In particular, the hinge thickness is less than the thickness of a portion of the walls 208, 212 that couple to the substantially linear portions of the hinge. Alternatively, the hinge 216 may have any suitable thickness. For example, one or both of the linear portions and/or the outer rounded portion may have varying thickness(es), thickness(es) greater than the thickness of the walls 208, 212, etc.

As shown in FIG. 1, each base portion 202, 204 of the base 200 define a support surface 234, 236, respectively, for receiving a pedestal dome. For example, the base portions 202, 204 may include a ledge or another suitable support surface between the upper portion 222 and the lower portion of the base 200. This ledge may support the pedestal dome when, for example, the edges 214, 230 are adjacent to each other (e.g., the base is in its closed position).

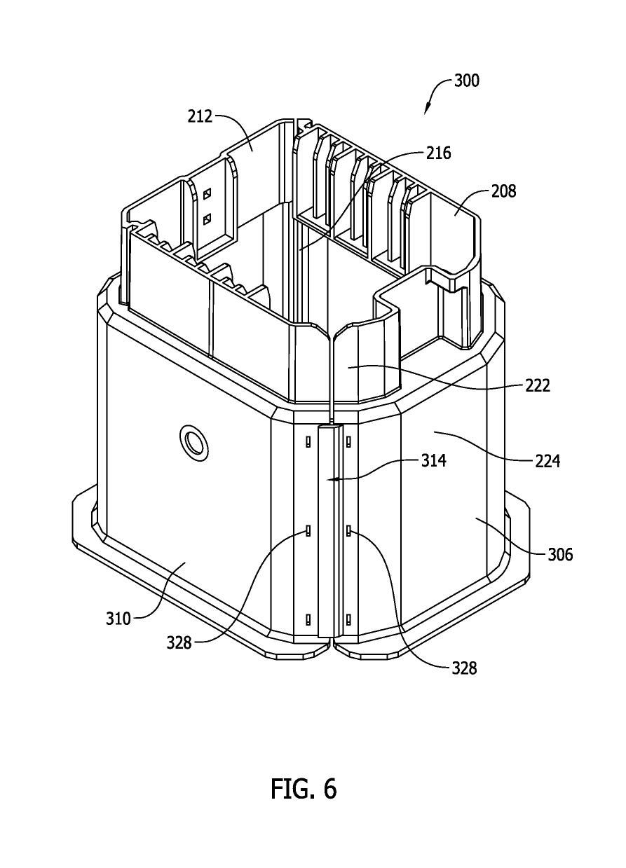

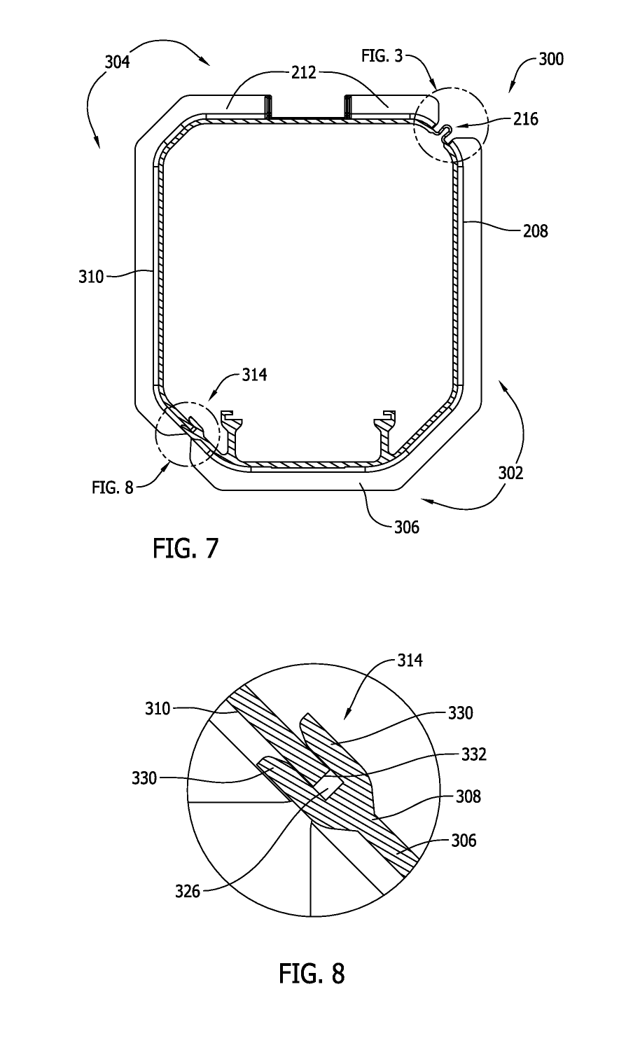

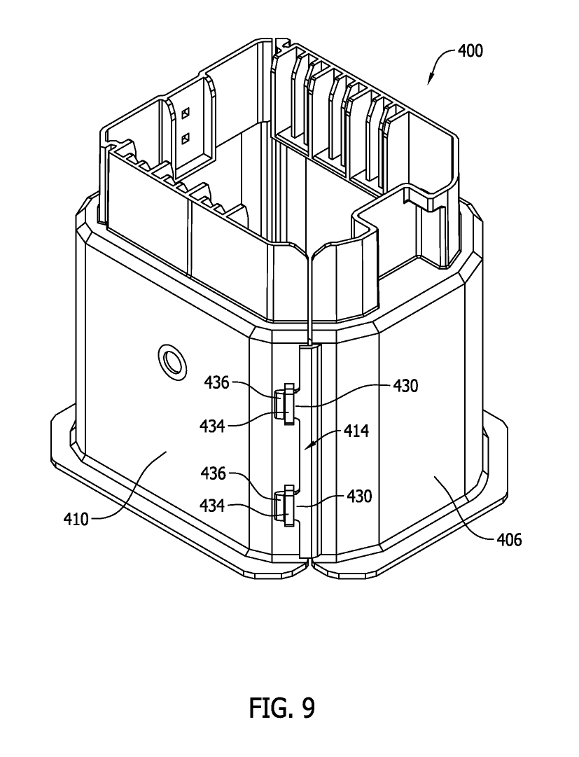

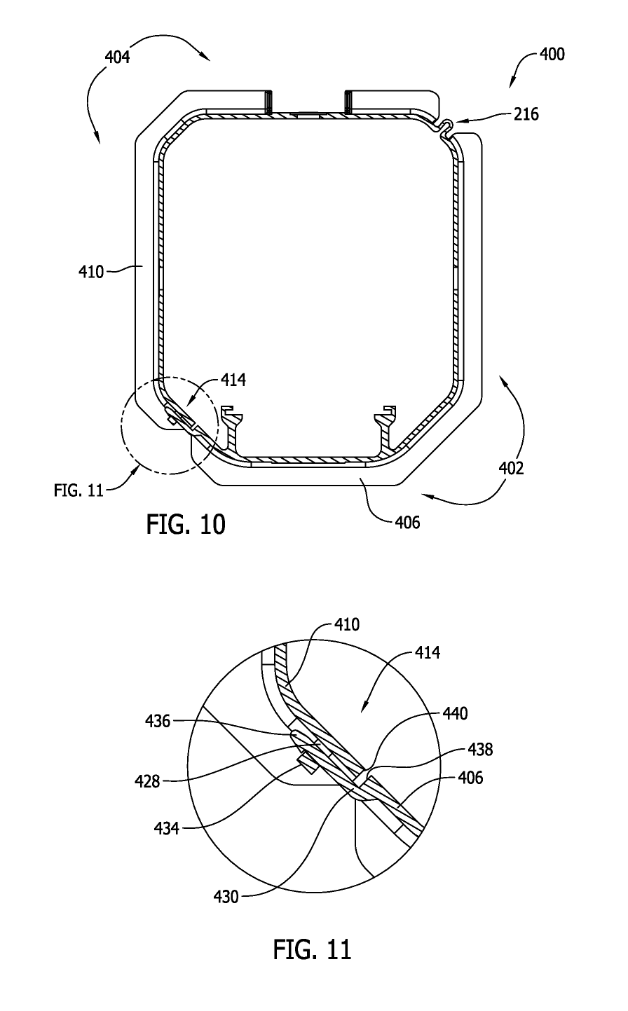

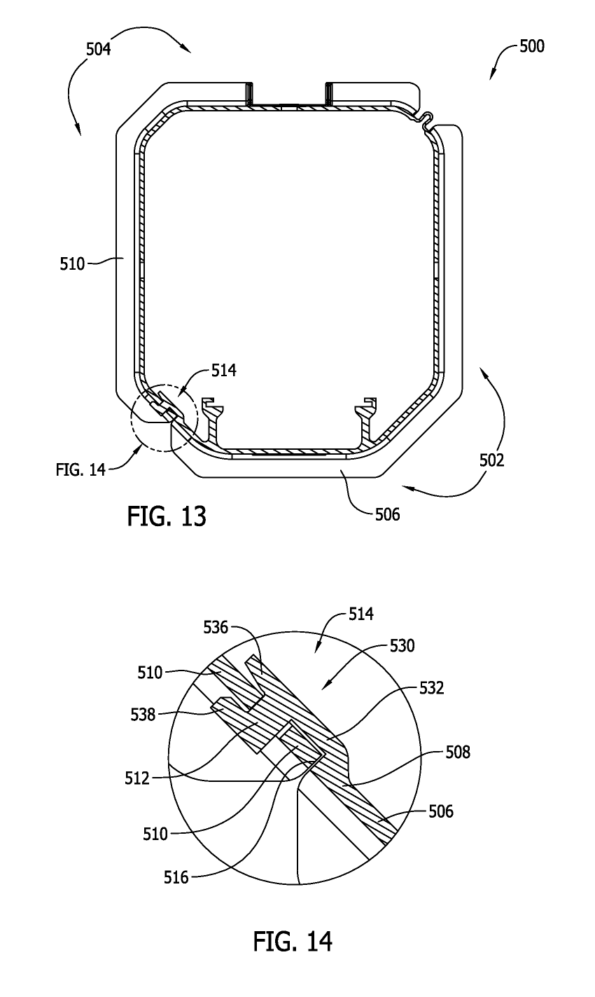

In some embodiments, the base 200 may include a fastening structure to couple the base portions 202, 204 together. For example, the fastening structure may be any suitable structure that couples the walls 206, 210 of the base portions 202, 204 and thereby ensures the base 200 is in its closed position. The fastening structure may include, for example, one or more of a tongue and slot configuration, a latch configuration, etc. Various example fastening structures that may be employed with the 200 are shown in FIGS. 6-14.

For example, FIGS. 6-8 illustrate an example telecommunications pedestal base 300 substantially similar to the base 200 of FIGS. 1-5. The base 300 of FIGS. 6-8, however, includes base portions 302, 304, the hinge 216 of FIGS. 1-3 coupled to the base portions 302, 304, and a fastener 314 coupled to and/or defined by the base portions 302, 304. The base portion 302 includes the wall 212 of FIG. 1 and a wall 310 adjacent the wall 212 and the base portion 304 includes the wall 208 of FIG. 1 and a wall 306 adjacent the wall 208. As shown in FIGS. 5 and 6, the fastener 314 is positioned in a corner of the base 300 (e.g., between the wall 306 and the wall 310) opposite the hinge 216.

As shown best in FIG. 8, the fastener 314 includes a tongue and slot fastening structure. For example, the wall 310 includes an edge 332, and the wall 306 includes an edge 308 and two flanges 330 (sometimes referred to as protrusions) extending from the edge 308. The flanges 330 create a fork-like structure and as such define a slot 326 therebetween for receiving a portion of the wall 310 (e.g., at least the edge 332). Thus, in the example of FIGS. 6-8, the wall 310 including its edge 332 may be considered the tongue portion and the slot 326 may be considered the slot portion of the fastener 314.

In such examples, the edge 332 of the wall 306 slides into the slot 326 thereby coupling the wall 306 to the wall 310 as explained above. In some examples, the edge 332 may have dimensions (e.g., a thickness) slightly smaller than the opening of the slots 326 to create, for example, a friction fit between the wall 306 and an interior side of each flange 330.

Additionally, and as illustrated in FIG. 8, the flanges 330 may include tapered ends to assist in inserting the edge 332 of the wall 306 into the slot 326. Additionally and alternatively, the flanges 330 may not include tapered ends, other suitable and/or optional features for inserting the edge 332 of the wall 306 into the slot 326 may be employed in addition to and/or alternative to the tapered ends, etc.

The flanges 330 and the slot 326 may extend vertically along the lower portion 224 of the base 300. For example, and as shown in FIG. 6, the flanges 330 and the slot 326 extend substantially the entire height of the lower portion 224. Alternatively, the flanges 330 and/or the slot 326 may extend another suitable distance including, for example, the entire height of the base 300, portions of and/or the entire height of the upper portion 222 of the base 300, portions of the lower portion 224, etc.

As shown in FIG. 6, the base 300 defines multiple slots 328 adjacent the fastener 314. In some examples, the slots 328 may be employed to receive tie wraps and/or other suitable fasteners to ensure the base 300 remains in its closed position. Although FIG. 6 illustrates the base 300 including six slots 328, more or less slots may be employed without departing from the scope of the present disclosure. For example, the base 300 may not include the slots 328, may include a different number of slots on each side of the fastener 314.

Although FIGS. 6-8 illustrate the base portion 302 including the slot portion of the fastener 314 and the base portion 304 including the tongue portion of the fastener 314, it should be apparent the base portion 302 may include one or more tongue portions and/or one or more slot portions and the base portion 304 may include one or more tongue portions and/or one or more slot portions. For example, the base portion 302 may include one tongue portion and one slot portion while the base portion 304 may include a corresponding slot portion and a corresponding tongue portion.

In other embodiments, a base may include a fastening structure having a different tongue and slot configuration. For example, FIGS. 9-11 illustrate another example telecommunications pedestal base 400 substantially similar to the base 300 of FIGS. 6-8. The base 400 of FIGS. 9-11, however, includes a fastener 414 having a tongue and slot configuration different than that of the fastener 314 of FIGS. 6-8.

As shown in FIGS. 9-11, the fastener 414 includes a tongue and slot configuration having a latching feature. For example, the base 400 includes base portions 402, 404 having walls 406, 410, respectively. The wall 410 includes an edge 440 and two latches 434 positioned adjacent the edge 440. The two latches 434 and the wall 410 define two slots 428. The wall 406 includes an edge 438 and two protrusions 430 extending from the edge 438 (e.g., in a different plane than the wall 406). As shown best in FIGS. 9 and 11, each protrusion 430 includes an end portion 436 defining a ledge or the like for abutting against a portion of each latch 434. Therefore, in the example of FIGS. 9-11, the latches 434 and its corresponding slots 428 may be considered the slot portion of the fastener 414 while the protrusions 430 may be considered the tongue portions of the fastener 414.

Each protrusion 430 including its end portion 436 may be slid into the corresponding slot 428 defined by each latch 434 and the wall 410. After a particular protrusion 430 is far enough through its corresponding latch 434, the ledge of the end portion 436 abuts against a portion of the latch 434 thereby coupling the walls 406, 410 together.

Additionally, and as shown in FIG. 11, the end portion 436 may include a tapered end to assist in aligning and/or inserting the end portion 436 into the slot 428 as explained above. Alternatively, the protrusions 430 including its end portion 436 and/or the latches 434 may be another suitable shape, configuration, etc. without departing from the scope of the present disclosure.

Further, although the fastener 414 of FIGS. 9-11 includes two latching features each having a tongue and slot configuration, it should be apparent that more or less latching features and/or alternative fastening structures may be employed without departing from the scope of the present disclosure.

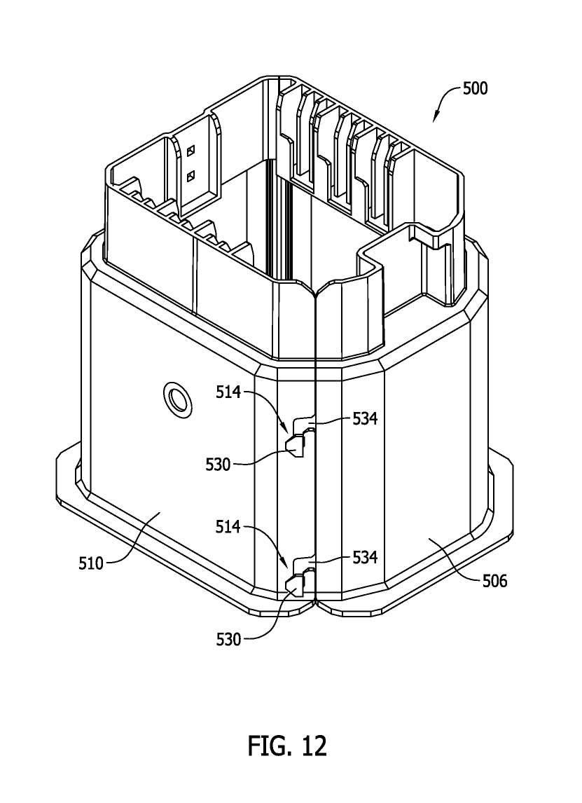

FIGS. 12-14 illustrate another example telecommunications pedestal base 500 substantially similar to the base 400 of FIGS. 9-11. The base 500 of FIGS. 12-14, however, includes a fastener 514 having bayonet configuration instead of a tongue and slot configuration.

As shown best in FIG. 12, the fastener 514 includes two bayonet connectors. For example, the base 500 includes base portions 502, 504 having walls 506, 510, respectively. The wall 510 includes an edge 516 and two slots 534 extending from the edge 516. In particular, each slot 534 includes a portion extending generally perpendicular from the edge 516 and another portion extending generally parallel to the edge 516. Thus, and as shown in FIG. 12, each slot 534 forms an “L” shape. Alternatively, one or both slots 534 may include another suitable configuration (e.g., another shape, etc.), more or less slots may be employed, etc. without departing from the scope of the present disclosure.

The wall 506 includes an edge 508 and two tabs 530 extending from the edge 508. As shown best in FIGS. 12 and 14, each tab 530 includes a portion 532 offset from the wall 506 and a knob 512 extending from the portion 532. Each offset portion 532 defines a recess for allowing each tab 530 to pass by the wall 510 as further explained below. Each knob 512 includes a protrusion 536 positioned adjacent an interior side of the base 500 and another protrusion 538 positioned adjacent an exterior side of the base 500. The protrusions 536, 538 form a fork-like structure and define a recess therebetween for receiving a portion of the wall 510 as further explained below. Alternatively, one or both tabs 530 may include another suitable configuration (e.g., another shape, more or less protrusions, etc.), more or less tabs may be employed, etc. without departing from the scope of the present disclosure.

To couple the walls 506, 510 together, each tab 530 may be guided into each corresponding slot 534 (e.g., the slot portion extending generally perpendicular to the edge 516 of the wall 510) with the protrusion 536 of the tab 530 on the interior side of the base 500 and the protrusion 538 on the exterior side of the base 500. Each tab 530 may then slide into the slot portion extending generally parallel to the edge 516. Thus, the recess between the protrusions 536, 538 receives an edge of the slot 534. As such, if the wall 506 is held substantially stationary, the wall 510 is prevented from substantially moving horizontally when each tab 530 is positioned in its corresponding slot portion extending generally parallel to the edge 516. The tabs 530 may remain in this position until an external force is applied to remove the tabs 530 from the slot 534 (e.g., a user forcing the tabs 530 upwards and out of the slots 534, etc.).

Additionally, and as illustrated in FIG. 14, the protrusions 536, 538 may include tapered ends to assist in guiding the edge of the slots 534 into the recess between the protrusions 536, 538. Additionally and alternatively, the protrusions 536, 538 may not include tapered ends as shown in FIG. 14, other suitable and/or optional features for guiding the edge of the slots 534 the recesses may be employed, etc.

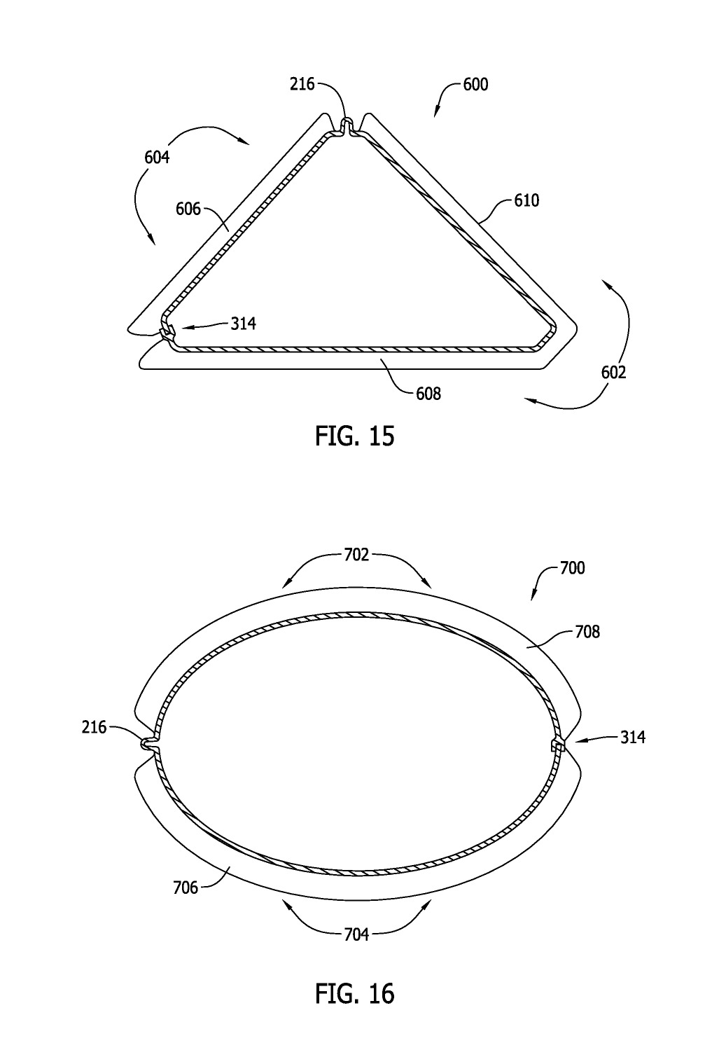

Although FIGS. 1-14 illustrate various example bases including base portions each having two walls, it should be apparent that one or both base portions may include more or less than two walls. For example, FIG. 15 illustrates an example telecommunications pedestal base 600 including a base portion 602 having two walls 608, 610, a base portion 604 including one wall 606, the fastener 314 of FIGS. 6-8, and the hinge 216 of FIGS. 1-5. As shown in FIG. 15, the three walls form a substantially triangular shape with respect to a top view of the base 600.

Additionally, FIG. 16 illustrates another example base 700 including a base portion 702 having one wall 708, a base portion 704 including one wall 706, the fastener 314 of FIGS. 6-8, and the hinge 216 of FIGS. 1-5. As shown in FIG. 16, each wall 706, 708 is curved to form a substantially clamshell like shape with respect to a top view of the base 700. Thus, the base 700 including its hinge 216 may sometimes be referred to as clamshell configuration.

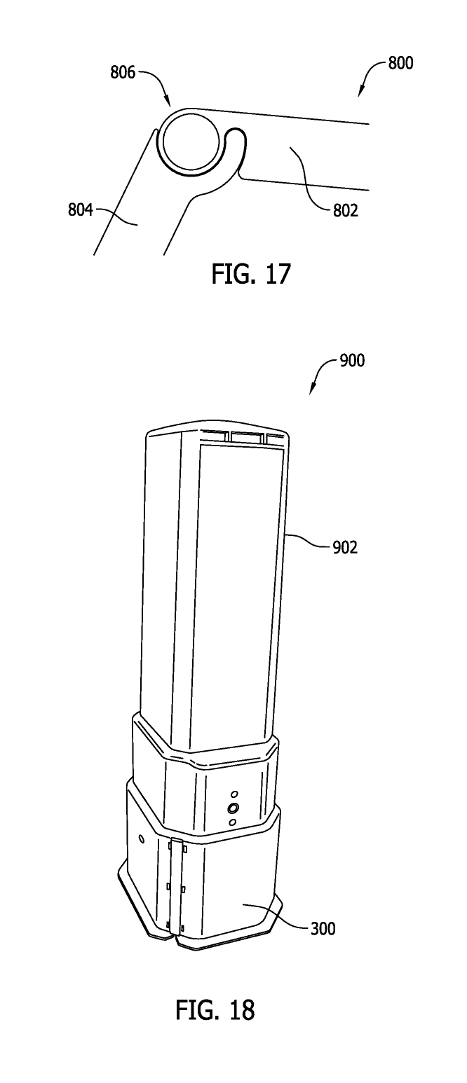

The telecommunications pedestal bases disclosed herein may have a one-piece construction (e.g., the bases shown in FIGS. 1-16). Alternatively, the bases may have a two-piece construction. For example, FIG. 17 illustrates a portion of a base 800 including walls 802, 804, and a hinge 806 coupling the walls 802, 804 together. Each wall 802, 804 may be at least a portion of a respective base portion. As such, one or both base portions (including its wall 802, 804) are movable about the hinge 806 relative to the other base portion as explained above. For example, and as shown in FIG. 17, the hinge 806 may allow a hinge portion extending from an edge of the wall 804 to rotate about a hinge portion extending from an edge of the wall 802.

Additionally, the hinge portions of FIG. 17 may be detachably coupled thereby allowing the walls 802, 804 to completely separate if desired. In such cases, the base 800 (including the hinge 806) may be considered a two-piece construction.

The bases and/or the hinges disclosed herein are preferably a non-metallic, flexible material such as a polymer. It should be apparent, however, the bases may be any other suitable material depending on, for example, the base application, the environment, etc. The flexibility and/or resiliency of the hinges and/or the base portions may vary depending on the material used, the application, etc.

Additionally, although the bases shown in FIGS. 1-17 include one hinge, it should be apparent that more than one hinge may be employed if desired. For example, two separate hinges (either identical or different) may be positioned in one corner of a base.

Further, although FIGS. 1-17 illustrate a particular hinge, it should be apparent that any suitable hinge may be employed without departing from the scope of the present disclosure. In some embodiments, the hinges may be formed monolithically with one base portion, the hinges and/or the base portions may be formed monolithically, etc. For example, one or more of the hinges may be considered what is commonly referred to as a living hinge.

The bases including any one or more of the various optional features disclosed herein may be employed in any suitable application. For example, the bases may be employed in a variety of pedestals including, for example, pedestals deployed indoors and/or outdoors (e.g., Outside Plant (OSP) pedestals, etc.).

FIG. 18 illustrates one example distribution pedestal 900 including a dome 902 and the base 300 of FIGS. 6-8 for supporting the dome 902. The dome 902 may be slid over a portion of the base 300 and then rest on a ledge or another suitable support surface as explained above. In some embodiments, the dome 902 may be coupled to, secured to, etc. the base 300. When the pedestal 900 is deployed, components (e.g., cables, etc.) may extend from beneath the ground through the base 300 and into an interior portion of the dome 902.

Although FIG. 18 illustrates the distribution pedestal 900 including the base 300, it should be apparent that other suitable bases including, for example, the base 200 of FIGS. 1-5, the base 400 of FIGS. 9-11, the base 500 of FIGS. 12-14, the base 600 of FIG. 15, the base 700 of FIG. 16, the base 800 of FIG. 17, etc. may be employed without departing from the scope of the present disclosure.

The distribution pedestal 900 may be any suitable pedestal housing components including, for example, cables, terminals, etc. For example, the pedestal may be used for electronic applications, broadband applications, telecommunication applications, fiber-optic applications, hybrid applications, etc.

By employing one or more of the features disclosed herein, a base having a single piece construction, a two-piece construction, etc. may be formed. By doing so, production, manufacturing, etc. of the bases may be less time consuming, cost less, less complex, etc. compared to, for example, other known bases. For example, suppliers, manufactures, etc. may reduce costs by molding a minimal amount of pieces (e.g., one piece, two pieces, etc.) for each base, reducing labor to manufacture the bases, reducing possible inventory issues (e.g., replacement parts, etc.), reducing production issues (e.g., maintenance, tools, management, employees, etc.), etc. Additionally, installation, maintenance, etc. of components (e.g., cables, etc.) may be less time consuming, cost less, less complex, etc. compared to, for example, other known bases.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A telecommunications pedestal base, the base comprising:
a first base portion including a wall having a first edge,
a second base portion including a wall having a second edge positioned adjacent the first edge, and
a hinge coupled to the first base portion and the second base portion,
the first base portion movable about the hinge relative to the second base portion to separate the first edge from the second edge and form an opening between the first edge and the second edge, the opening providing access to an interior of the base.

2. The telecommunications pedestal base of claim 1 wherein the first base portion is movable by force about the hinge relative to the second base portion, and wherein the second edge substantially returns to its position adjacent the first edge when the force is removed.

3. The telecommunications pedestal base of claim 1 wherein the hinge is formed monolithically with the first base portion.

4. The telecommunications pedestal base of claim 1 wherein the first base portion is formed monolithically with the second base portion.

5. The telecommunications pedestal base of claim 1 wherein the base has a one piece construction.

6. The telecommunications pedestal base of claim 1 wherein the base has a two piece construction.

7. The telecommunications pedestal base of claim 1 wherein the first base portion and the second base portion define a support surface for receiving a pedestal dome.

8. The telecommunications pedestal base of claim 1 wherein the hinge includes a substantially vertical hinge.

9. The telecommunications pedestal base of claim 8 wherein the substantially vertical hinge extends a distance less than a height of the telecommunications pedestal base.

10. The telecommunications pedestal base of claim 8 wherein the wall of the first base portion is a first wall and wherein the first base portion includes a second wall having an edge, and wherein the hinge is coupled to the edge of the second wall.

11. The telecommunications pedestal base of claim 1 further comprising at least one fastener for coupling the first base portion and the second base portion.

12. The telecommunications pedestal base of claim 11 wherein the at least one fastener includes a tongue and slot fastener.

13. The telecommunications pedestal base of claim 11 wherein the at least one fastener includes a bayonet connector.

14. The telecommunications pedestal base of claim 1 wherein the base is deployed with cables extending at least partially through the base.

15. A distribution pedestal including a dome and the telecommunications pedestal base of claim 1 configured to support the dome.

16. A method of installing a telecommunications pedestal base about cables in a telecommunications system, the telecommunications pedestal base including a first base portion having a first edge, a second base portion having a second edge adjacent the first edge, and a hinge coupled to the first base portion and the second base portion, the method comprising:
separating the first edge of the first base portion from the second edge of the second base portion so that the first base portion moves about the hinge relative to the second base portion to form an opening between the first edge and the second edge; and
moving the telecommunications pedestal base to allow the cables to pass through the opening between the first edge and the second edge and into an interior of the base.

17. The method of claim 16 wherein separating includes separating by force the first edge of the first base portion and the second edge of the second base portion.

18. The method of claim 17 further comprising releasing the first base portion so that the first edge substantially returns to its position adjacent the second edge when the force is removed.
